(19) United States
(12) Patent Application Publication
(10) Pub. No.: US 2007/0053197 A1
(43) Pub. Date: Mar. 8, 2007

(54) Backplate assembly for a vehicle tail lamp

(75) Inventor: John E. Burton, Ludington, MI (US)

Correspondence Address: GODFREY & KAHN S.C., 780 NORTH WATER STREET, MILWAUKEE, WI, 53202, US

(73) Assignee: Burton Technologies, LLC

(21) Appl. No.: 11/222,502

(22) Filed: Sep. 8, 2005

(51) Int. Cl. B60Q 1/26

(52) U.S. Cl. 362/540

(57) ABSTRACT

A backplate assembly for a vehicle tail lamp is disclosed. The backplate assembly includes a back housing, a front housing secured to the back housing, a one-piece circuit disposed between the front housing and the back housing, a plurality of bulb clips disposed at least partially between the front housing and the back housing, and at least one fastening screw that passes through the front housing and the back housing to fasten the backplate assembly to the vehicle tail lamp.

### BACKGROUND OF THE INVENTION

This invention relates generally to vehicle lamp assemblies. Specifically, this invention relates to a backplate assembly for a tail lamp of a motor vehicle.

Backplate assemblies are designed to accommodate multiple bulbs using a single assembly and are commonly used in connection with tail lamps of vehicles. The backplate assemblies typically include a single connector that connects the bulbs to the wiring harness of a vehicle. The use of a single backplate assembly for multiple bulbs allows the tail lamps or other lamp assemblies to be easily pre-assembled prior to installation into the vehicle. The lamp assemblies can then be installed in the vehicle as a single unit, and connected to the vehicle's wiring harness using the single connector.

There are several types of backplate assemblies currently in use for vehicle lamps. One type of backplate assembly is disclosed in U.S. Pat. No. 6,139,334 to Forish et al. The backplate disclosed therein includes front and back panels. The panels include apertures that align with one another when assembled. A number of conductors are disposed between the front and back panels. The conductors engage contact pads within a lamp socket assembly that extends into the apertures. The backplate assembly, including the lamp socket assemblies, may be attached to a lamp assembly, such as a tail lamp, of a motor vehicle.

One problem associated with existing backplate assemblies is the use of multiple conductors for the multiple socket assemblies. The use of multiple conductors adds cost and creates intermediate connections that need to be controlled during assembly of the backplate and maintained during the life cycle of the lamp assembly.

Also, since backplate assemblies are generally elongated structures, controlling bulb position concentric within each reflector and maintaining an air tight seal to the tail lamp becomes problematic. In practice, the elongated shape of the backplate has required as many as six attachment points in order to counteract warping and deflection from the force required to compress the gaskets that surround each bulb against the tail lamp reflector housing. Alignment of the bulbs concentric to the reflector, alignment of the multiple fastening points, and controlling gasket compression for an air tight seal becomes a difficult task due to the number of features to control and each of their related tolerances. Further, the use of snap fits requires more complex and higher maintenance tooling for the reflector and has been found to be less reliable in providing a detachable yet secure attachment.

Finally, the terminal pins that protrude from the backplate and engage the wire harness connector need to be securely held in alignment to prevent interference or bending of the terminal pins when the connector is attached to the backplate. This terminal pin alignment has been typically achieved by inserting the terminal pins through closely fitted holes in the panel of the backplate. However, since the terminal pins are part of a large stamped conductor, simultaneously threading the plurality of terminal pins through the closely fitted holes in the panel becomes difficult. The assembly process is slowed and the possibility of bending of the terminals during assembly is increased.

Accordingly, a need exists for an improved backplate assembly that solves these and other deficiencies in the prior art. Of course, the present invention may be used in a multitude of situations where similar performance capabilities are required.

### SUMMARY OF THE INVENTION

The present invention provides a backplate assembly for a tail lamp. The backplate assembly includes a front housing, a back housing secured to the front housing, a circuit disposed between the front housing and the back housing, a plurality of bulb clips disposed partially between the front housing and the back housing and functionally engaging the circuit, and at least one fastening screw. The circuit is a one-piece circuit formed from a single progressive die stamping process that initially starts as a flat shape and is then progressively formed and bent into the final assembly shape. The circuit includes separation points to allow the creation of independent circuits from the one-piece stamping but eliminates the need for additional conductors since it provides a direct electrical connection from the wire harness connector to the bulb. The at least one fastening screw passes through the front housing and the back housing to engage the tail lamp assembly in an orientation parallel to, in-between and generally within the longitudinal plane of the bulb clips to control bulb position within the tail lamp and reduce the number of fastening points to attach the backplate. The front housing and back housing form a ridged “T” shaped structure to minimize deflection and warping when fastened to the tail lamp. The front housing has slotted rectangular holes that when combined with blades on the back housing secure the position of the terminal pins.

The present invention also contemplates a tail lamp assembly for a vehicle. The tail lamp assembly includes a tail lamp housing, a plurality of reflectors disposed at least partially within a housing that can have a lens or a plurality of lenses, and a backplate assembly including a front housing, a back housing secured to the front housing, a one-piece circuit disposed between the front housing and the back housing, a plurality of bulb clips disposed partially between the front housing and the back housing and functionally engaging the circuit, and at least one fastening screw. The tail lamp assembly further includes at least one screw hole to receive the at least one fastening screw, a plurality of bulbs mounted in the bulb clips, and at least one gasket mounted on the exterior of the back housing of the backplate assembly. The at least one fastening screw passes through the front housing and the back housing of the backplate assembly to engage the at least one screw hole.

The backplate assembly and tail lamp assembly of the present invention have several advantages over existing assemblies. In particular, the use of a one-piece circuit manufactured from a single stamping reduces the number of intermediate connections that need to be made during the assembly process and also reduces the number of connection points in the circuit that are susceptible to failure during the life of the tail lamp.

As well, the use of at least one fastening screw that passes through both the front housing and the back housing in an orientation parallel to, in-between and generally within the longitudinal plane of the bulb clips reduces the number of attachment points required to hold the backplate assembly in place and provides a better seal between the backplate assembly and the tail lamp assembly. The at least one fastening screw can help to locate the position of the bulbs concentric to the reflector by serving as the primary “six way” position locator between the backplate and tail lamp housing. The placement of the at least one screw in-between the bulb clips reduces the cantilevered forces from the gasket compression on either side and combined with the rigid “T” shaped cross-section of the backplate minimizes warpage and deflection. Only one screw is needed for a two bulb backplate and only one additional screw is needed for either a three or four bulb backplate. If a second screw is used, it is preferably positioned parallel and generally within the longitudinal plane of the bulb clips and serves as a secondary “four way” locator.

Finally, the large slotted rectangular holes in the front housing with lead-in chamfers provide quick and easy insertion of the plurality of terminal pins on the stamped circuit. The blades on the back housing are dimensioned to snugly fit between each pair of terminal pins so that, when assembled to the front housing, the stamped circuit terminal pins are spread apart by the blades and securely held in position.

While one possible application of the present invention is in connection with a vehicle tail lamp, many other applications are possible and references to use in connection with a vehicle lamp should not be deemed to limit the uses of the present invention. The terms used herein should not be interpreted as being limited to specific forms, shapes, or compositions. Rather, the parts may have a wide variety of shapes and forms and may be composed of a wide variety of materials. These and other objects and advantages of the present invention will become apparent from the detailed description, claims, and accompanying drawings.

### DESCRIPTION OF THE DRAWINGS

FIG. 1 is a perspective view of a tail lamp assembly incorporating one embodiment of a backplate assembly of the present invention;

FIG. 2 is a perspective view of the backplate assembly of FIG. 1;

FIG. 3 is a partially exploded perspective view of the backplate assembly of FIG. 2, showing the front housing removed from the backplate assembly;

FIG. 4A is a rear perspective view of the front housing for the backplate assembly;

FIG. 4B is a detail view of a portion of the front housing of FIG. 4, shown with the circuit 16 installed thereto;

FIG. 4C is a detail view of a portion of the front housing of FIG. 4;

FIG. 4D is a detail view of another portion of the front housing of FIG. 4;

FIG. 5A is an exploded perspective view of the backplate assembly of FIG. 2;

FIG. 5B is a detail view of a bulb clip shown in FIG. 5;

FIG. 5C is a detail view of the blades on the back housing shown in FIG. 5;

FIG. 6 is a perspective view of one embodiment of a circuit used in connection with the backplate assembly of the present invention, showing the circuit as-stamped from a single sheet of conductive material;

FIG. 7 is a perspective view of the circuit of FIG. 6, showing the circuit bent into a shape appropriate for insertion into the backplate assembly;

FIG. 8 is a cross-sectional view of the backplate assembly of FIG. 2 taken along plane 8-8 in FIG. 2;

FIG. 9 is a cross-sectional view of the backplate assembly of FIG. 1 taken along plane 9-9 in FIG. 1;

FIG. 10 is a cross-sectional view of the backplate assembly of FIG. 1 taken along plane 10-10 in FIG. 1;

FIG. 11 is a cross-sectional view of the backplate assembly of FIG. 1 taken along plane 11-11 in FIG. 1;

FIG. 12 is a cross-sectional view of the backplate assembly of FIG. 2 taken along plane 12-12 in FIG. 2;

FIG. 13 is a cross-sectional view of the backplate assembly of FIG. 2 taken along plane 13-13 in FIG. 2;

FIG. 14 is a perspective view of another embodiment of a backplate assembly according to the present invention;

FIG. 15 is a partially exploded perspective view of the backplate assembly of FIG. 14, showing the front housing removed from the backplate assembly; and

FIG. 16 is an exploded perspective view of the backplate assembly of FIG. 14.

### DETAILED DESCRIPTION OF THE PREFERRED EMBODIMENTS

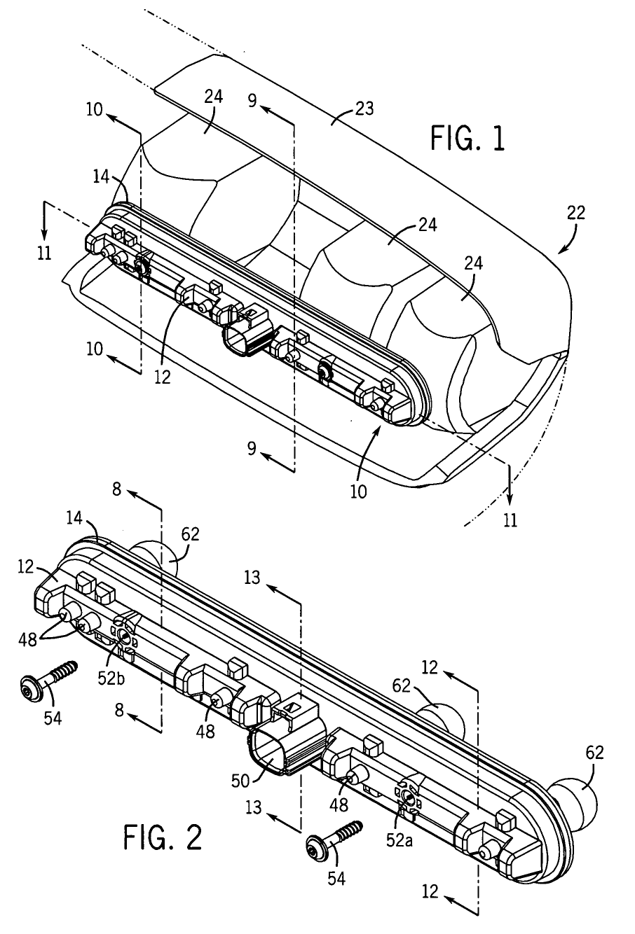

Referring now to the drawings, the backplate assembly 10 of the present invention includes a front housing 12, a back housing 14, a circuit 16, a plurality of bulb clips 18, and a plurality of gaskets 20. FIG. 1 shows one embodiment of a backplate assembly 10 installed as part of a tail lamp assembly 22. The tail lamp assembly 22 includes a housing 23 that may have a lens or a plurality of lenses (not shown), and a plurality of reflectors 24 onto which the backplate assembly 10 attaches. Bulbs 62 (not shown in FIG. 1) are disposed between the housing 23 and reflectors 24 and are mounted in connection with the backplate assembly 10 as shown in FIG. 2.

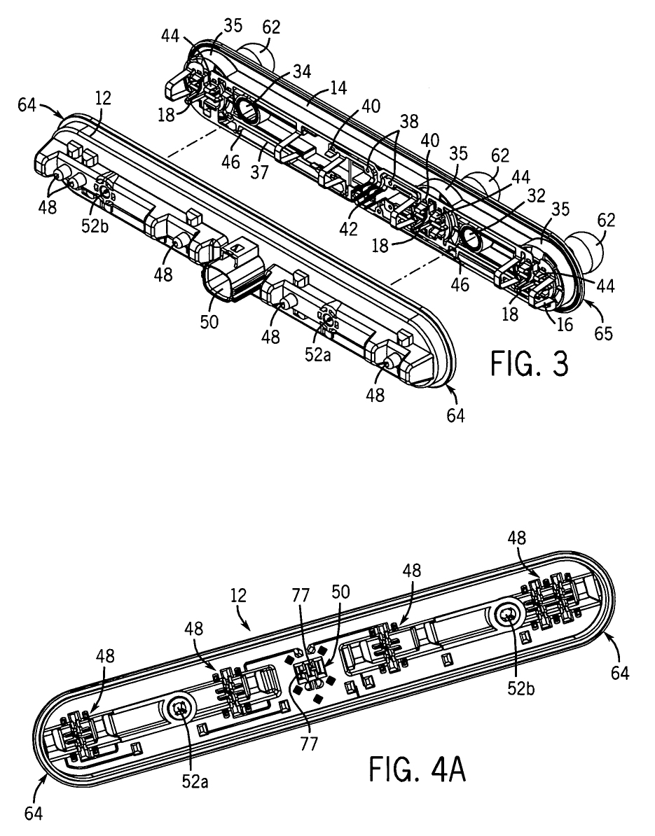

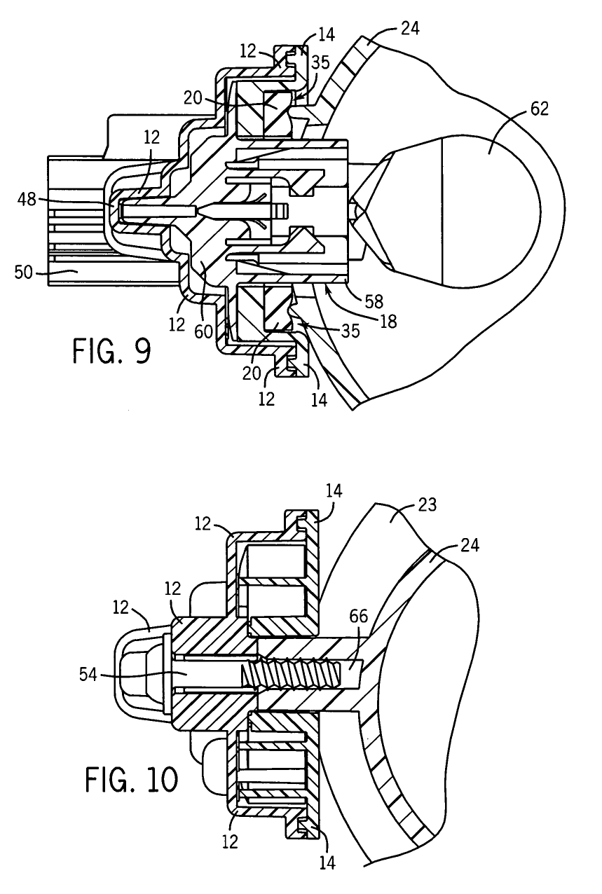

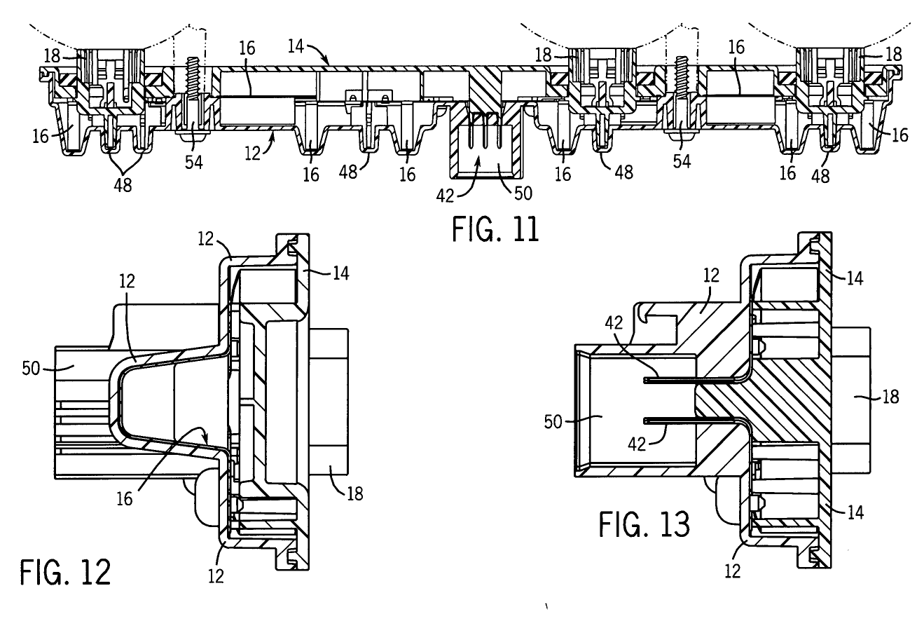

FIGS. 2-13 show the backplate assembly 10 of FIG. 1 in more detail. The back housing 14 is a long, flat, substantially oval shape and includes three apertures 26 to accommodate bulb clips 18, a first mounting locator 32 and a second mounting locator 34. In alternative embodiments, different numbers of apertures 26 and bulb clips 18 could be used. Apertures 26 each include an annular channel 35 formed around the outside thereof to accommodate gaskets 20. The first mounting locator 32 is preferably a round shape and the second mounting locator 34 is preferably an oval or oblong shape to facilitate assembly and alignment of the backplate assembly 10 as described in more detail below. The back housing could be of other shapes, and could include any number of apertures and mounting locators in a variety of different shapes and configurations. The back housing is preferably formed from a thermoplastic material using an injection molding process, though other materials and manufacturing processes could also be used.

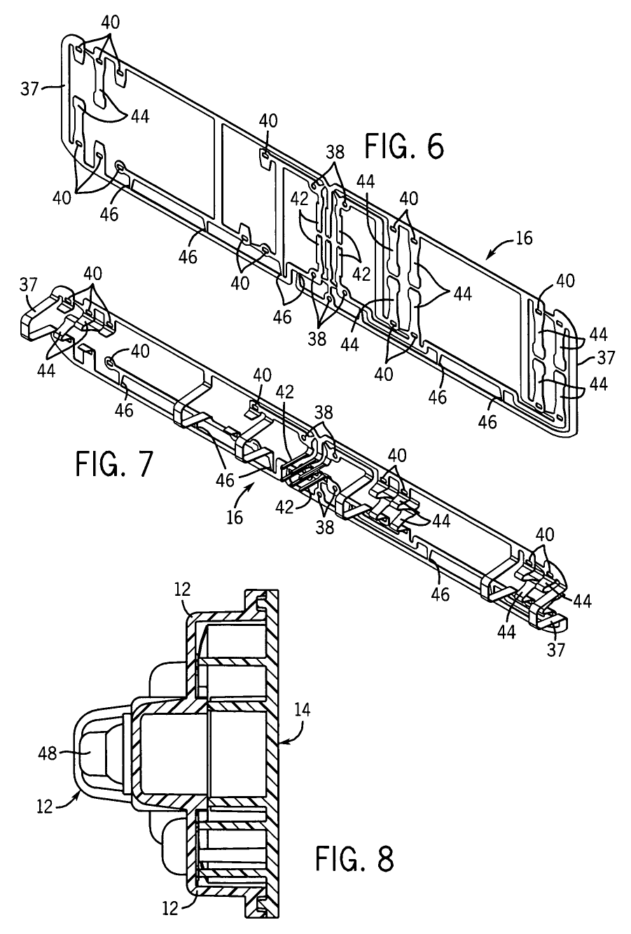

The circuit 16 is formed as a single piece in a single progressive die stamping process, and can be of a number of different metal or other conductive materials. It has been found beneficial to use a plated steel material for the stamped circuit 16. The one-piece circuit 16 starts as a flat shape in the progressive die stamping process such as the flat shape shown in FIG. 6. The flat shape may include bridges 37, terminal pins 42, bulb contacts 44, center holes 38, attachment holes 40, and separation points 46. The flat stamping is then progressively formed and bent into a shape appropriate for assembly, for example, the shape shown in FIG. 7. In this embodiment, because of the unique opposing design of the circuit 16 wherein pairs of terminal pins 42 and bulb contacts 44 are positioned across from each other, bridges 37 may be easily bent and shaped so as to complete the finished shape of the circuit 16 ready for assembly. In the bent shape, the terminal pins 42 are perpendicular to the flat stamping and the bulb contacts 44 are bent into substantially a “v” shape. The rest of the circuit 16 is bent as necessary to ensure that the terminal pins 42 and bulb contacts 44 will assume the proper orientations when assembled. Center holes 38 are preferably a round shape, and attachment holes are preferably an oblong or “double D” shape to facilitate assembly and alignment of the circuit 16 in the back housing 14 as described in more detail below and to allow for any thermal expansion difference between the metal circuit 16 and plastic parts. Other shapes and configurations could also be used, particularly if more or less than three bulbs are used in the assembly.

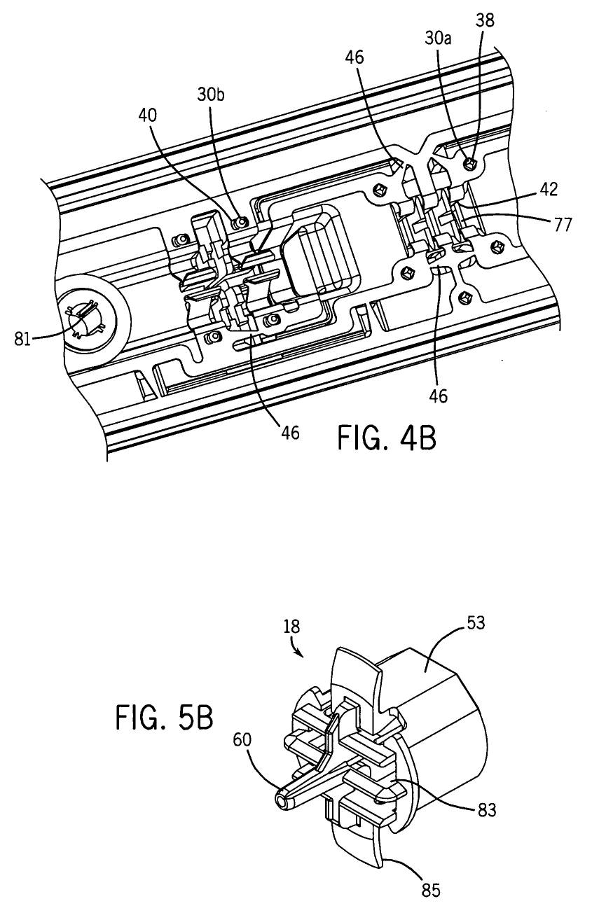

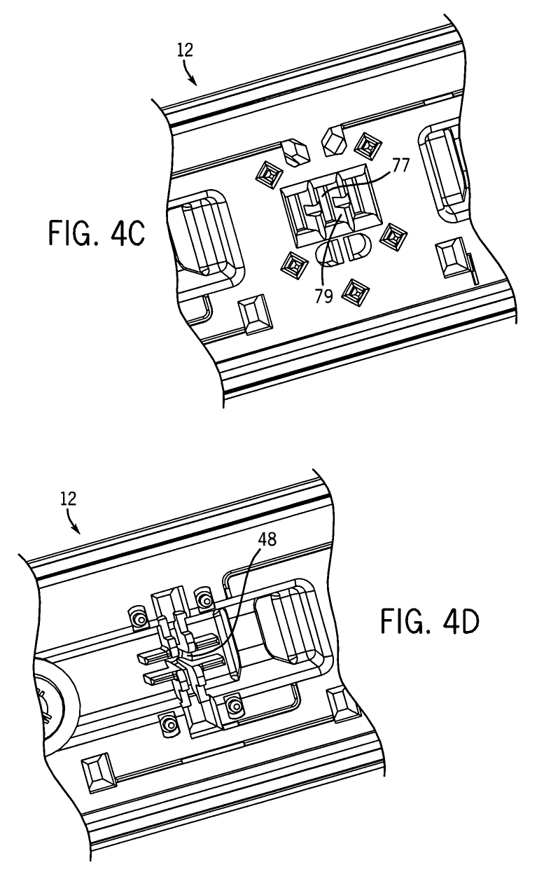

The front housing 12 is shaped to enclose the circuit 16 and facilitate connection to the wiring harness (not shown) for the vehicle (not shown). The front housing 12 includes bulb pockets 48 to receive the bulb clips 18, a plug receptacle 50 for the vehicle wiring harness (not shown), a plurality of integrally formed posts 30a, 30b, and openings 52a, 52b for fastening screws 54. Referring to FIGS. 4A-D, the wiring harness plug receptacle 50 includes slotted rectangular holes 77 for keeping the terminal pins 42 separated when the backplate assembly 10 is assembled. As well, opening 52a has an oval shape on the interior side of the front housing 12 and opening 52b has a round shape. The shape of the openings 52a, 52b can facilitate assembly and alignment of the backplate assembly 10, as described in more detail below, however, other shapes can also be used. Posts 30a, 30b can be of varying sizes and shapes to facilitate assembly and positioning of the circuit 16. For example, center posts 30a can have a square cross-section, and attachment posts 30b can have a round cross-section to facilitate assembly and proper alignment of the circuit 16 as described in more detail below. Like the back housing, a number of different materials and manufacturing process could be used to create the front housing, but it has been found beneficial to use a thermoplastic material in an injection molding process.

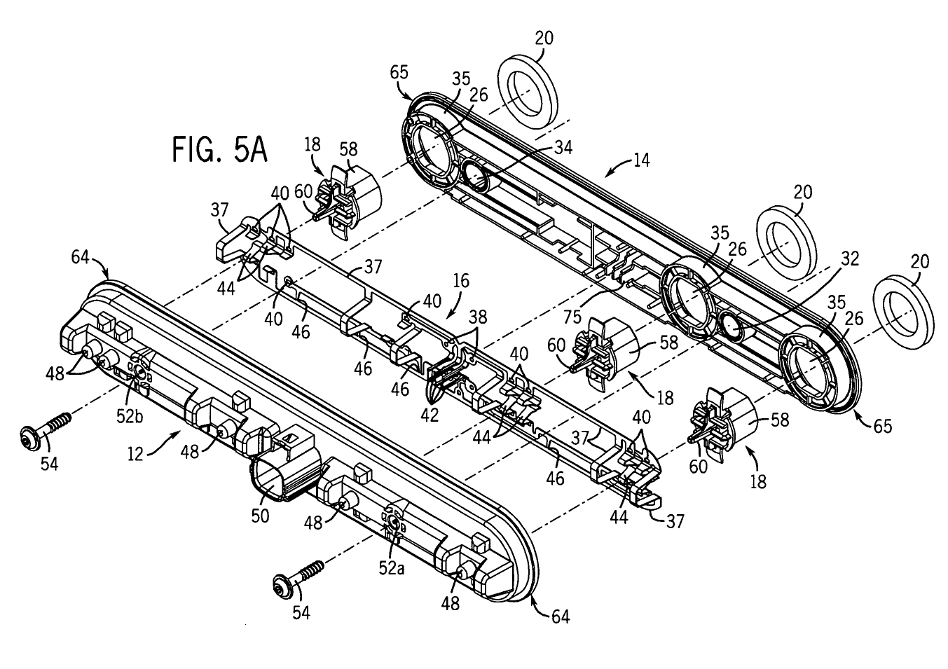

As shown in detail in FIG. 5B, bulb clips 18 include a bulb receptacle 58, a mounting rod 60, wings 85 and fin 83. The mounting rod 60 is formed in the shape of a cruciform and guides and orients the bulb clip 18 as it is inserted into bulb pocket 48 of front housing 12. The fin 83 is formed to separate bulb contacts 44 and bulb receptacles 58 are formed to receive bulbs 62. During insertion, the fin 83 separates the bulb contacts 44 to the proper gap distance within the bulb clips 18 to create the correct contact surface for bulbs 62 within bulb receptacles 58. The bulb clips 18 are preferably molded from a thermoplastic material, but could be formed from a number of different materials using a number of different manufacturing processes. The gaskets 20 can be molded from a cellular foam rubber material, such as that commonly known as EPDM (Ethylene Propylene Diene Monomer), but other materials and manufacturing processes could also be used. Other gasket configurations could also be used, including but not limited to the use of a single gasket on the exterior surface of the back housing 14.

To assemble the backplate assembly 10, the circuit 16 is inserted into the front housing 12. To do so, the center holes 38 on the circuit 16 are aligned with center posts 30a in the front housing 12 and the attachment holes 40 are aligned with attachment posts 30b. The circuit 16 is then pushed on to the front housing 12 such that center posts 30a extend through center holes 38 and attachment posts 30b extend through attachment holes 40. As previously described, the center holes 38 are round in cross-section, and the center posts 30a are square in cross-section. The difference in cross-section between the center holes 38 and the center posts 30a create interference therebetween and thus the circuit 16 is maintained in the appropriate position when the center posts 30a are inserted through the center holes 38. This interference acts like a retaining clip and completely secures the circuit 16 to the front housing 12 eliminating the need for heat staking the attachment posts over the circuit. Heat staking is a typical operation used in the prior art and eliminating this operation reduces assembly expense. The center holes 38 and center posts 30a are thus used to properly align and position the circuit 16 on the front housing 12. The attachment holes 40, however, are oblong, oval or “double D” shaped in cross-section while the attachment posts 30b are round in cross-section. The oblong shape of the attachment holes 40 versus the round shape of the attachment posts 30b allow room for expansion and tolerance variances between the circuit 16 and the front housing 12. Although the shapes described above with respect to the center posts 30a, center holes 38, attachment posts 30b and attachment holes 40 have been found beneficial and are therefore preferred, other shapes and sizes could also be used in connection with the backplate assembly 10 of the present invention. For instance, the holes 38, 40 and posts 30a, 30b could all be round or could all be square in cross-section.

After the circuit 16 is inserted into the front housing 12 as described above, the separation points 46 must be trimmed or separated from the circuit body to create independent circuits for each bulb 62. The separation points 46 can be trimmed in a number of ways, but it has been found effective to first hold down circuit 16 with a stripper plate and then simultaneously trim the separation points with die punches that pass through the stripper plate.

Once the separation points 46 are trimmed, the mounting rod 60 of the bulb clips 18 are inserted into bulb pockets 48 of the front housing 12 and press-fit and seated into place. During insertion, the cruciform shaped mounting rod 60 is aligned and guided by the bulb pockets 48 having the same cruciform shape and is dimensioned to have a controlled interference between the two. Also, as the bulb clips 18 are inserted, the bulb contacts 44 are pushed apart to the correct gap distance by fin 83. After all of the bulb clips are seated into place, the back housing 14 can then be installed. The back housing 14 is formed to accommodate the shape of the circuit 16, and can thus be aligned with the circuit 16 and fastened in place. As the back housing 14 is being installed, the wings 85 on the bulb clips 18 are compressed, clamping it against the circuit 16 and front housing 12. Also during installation, blades 75 on the back housing 14 are inserted inside the slotted rectangular holes 77 in the front housing 12 and between pairs of the terminal pins 42 on the circuit 16. After installation, the blades 75 secure and align the terminal pins 42 inside the slotted rectangular holes 77, as best shown in FIG. 13. Many methods for fastening the front housing 12 in place could be used. Ultrasonic welding the perimeter edge 64 of the front housing 12 to the perimeter edge 65 of the back housing 14 is one such method that works well for this application. Once the back housing 14 is installed, the bulb clips 18 cannot move and the bulb clips 18 help hold the circuit 16 and terminal pins 42 securely in place. The gaskets 20 and screws 54 can then be installed. The gaskets 20 are pressed into the annular channels 35 and stay in place because of an interference fit between the gasket 20 and the annular channel 35. The screws 54 are installed into their respective openings 52a and 52b in the front housing 12. Openings 52a and 52b also include screw retaining fingers 81 that lightly grip the screw threads during installation and captivate the screws 54 inside their respective openings 52a and 52b. Once the gaskets 20 and screws 54 are installed, the backplate assembly 10 is complete.

The assembled backplate assembly 10 can be installed as part of a tail lamp assembly 22 as shown best in FIG. 1. First, the bulbs 62 are inserted into the bulb receptacles 58, where they contact the bulb contacts 44. Next, the backplate assembly 10 including the bulbs 62 is aligned with the tail lamp assembly 22 such that bulbs 62 are disposed between the reflectors 24 and the housing 23 of the tail lamp assembly 22. The tail lamp assembly 22 includes two screw bosses 66 shown best in FIG. 10 that align with the mounting locators 32, 34 of the back housing 14. The captivated screws 54 are then driven into screw bosses 66 in the tail lamp assembly 22. The shape of the mounting locators 32, 34 help facilitate the installation and alignment of the backplate assembly 10 to the tail lamp assembly 22. The round shape of mounting locator 32 in combination with a screw boss 66 serves as the primary “6-way” locator to allow the backplate assembly 10 to be properly aligned with respect to the tail lamp assembly 22. The primary locator fixes the position of the back plate in both directions of all three principle axes (X, Y and Z) and is hence called a “6-way” locator. The oval or oblong shape of mounting locator 34 in combination with a screw boss 66 allows for just longitudinal tolerance variances between the screw boss 66 and mounting locator 34 and is hence called a “4-way” locator. Other shapes could also be used, however. The heights of both screw bosses 66 are in the same plane and determine the compression of gaskets 20 for a controlled air tight seal. Once installed, the longitudinal axis of the fastening screw 54 passes through the front housing 12 and the back housing 14 in an orientation parallel to and generally within the longitudinal plane of the bulb clips 18. This configuration provides a more controlled seal and better bulb alignment between the backplate assembly 10 and the tail lamp assembly 22, and requires less assembly steps than other methods of installing backplate assemblies.

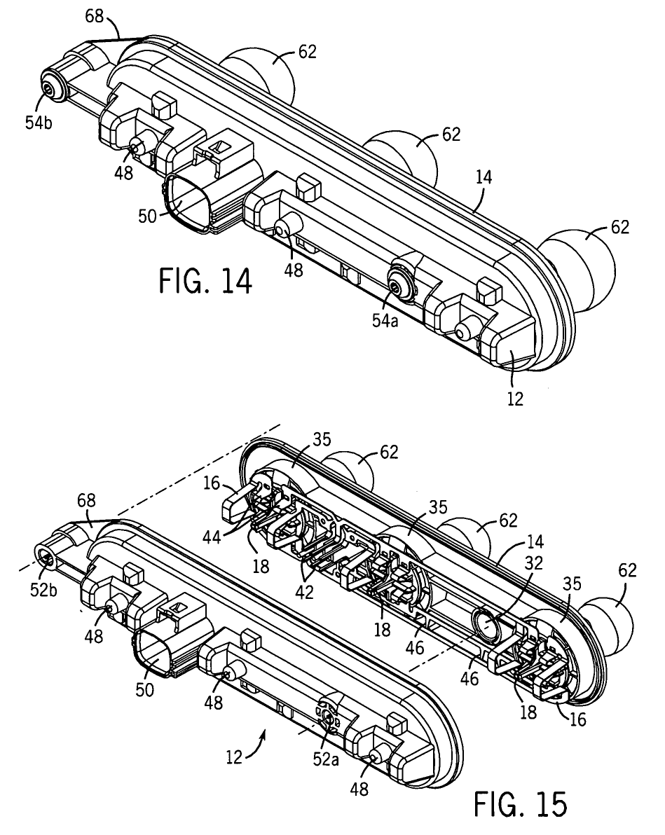

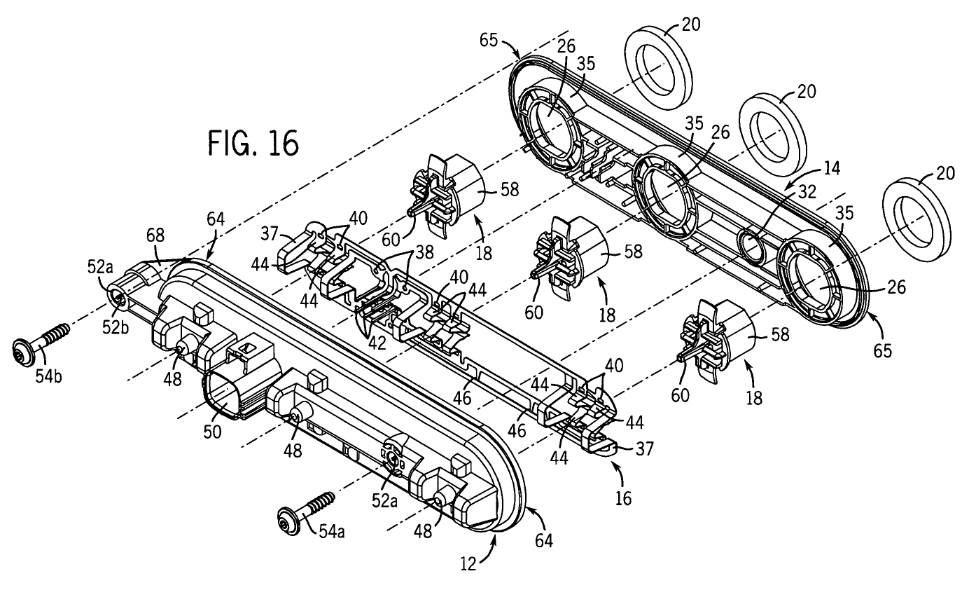

Another embodiment of the backplate assembly 10 of the present invention is shown in FIGS. 14-16. The embodiment shown in FIGS. 14-16 includes only a first fastening screw 54a that passes through both the front housing 12 and back housing 14. A second fastening screw 54b passes through the front housing 12 but not the back housing 14. To accommodate the second fastening screw 54b, the front housing 12 also includes an extension 68 through which the second fastening screw 54b passes. Like the first fastening screw 54a, the second fastening screw 54b aligns with and threads into a screw boss in the tail lamp assembly, but does not pass through the back housing 14. The remaining features of the embodiment shown in FIGS. 14-16 are analogous to those described above for the embodiment shown in FIGS. 1-13.

Although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims.

What is claimed is:

1. A backplate assembly comprising:
a front housing;
a back housing secured to the front housing;
a circuit disposed between the front housing and the back housing, wherein the circuit is formed as a single stamping; and
a plurality of bulb clips disposed partially between the front housing and back housing and functionally engaging the circuit.

2. The backplate assembly of claim 1, further comprising a plurality of gaskets mounted in connection with the back housing and surrounding the bulb clips.

3. The backplate assembly of claim 1, further comprising at least one fastening screw that passes through the front housing and the back housing to secure the backplate assembly to a tail lamp assembly for a vehicle.

4. The backplate assembly of claim 1, further comprising a first fastening screw and a second fastening screw, wherein the first fastening screw and the second fastening screw pass through the front housing and the back housing to secure the backplate assembly to a tail lamp assembly for a vehicle.

5. The backplate assembly of claim 4, wherein the back housing includes a first mounting boss and a second mounting boss and wherein the first fastening screw passes through the first mounting locator and the second fastening screw passes through the second mounting locator.

6. The backplate assembly of claim 5, wherein the first mounting locator has a round shape and the second mounting locator has an oblong shape.

7. The backplate assembly of claim 1, wherein the circuit includes center holes and attachment holes.

8. The backplate assembly of claim 7, wherein the front housing includes center posts and attachment posts and wherein the center holes of the circuit engage the center posts of the front housing and the attachment holes of the circuit engage the attachment posts of the front housing.

9. The backplate assembly of claim 1, wherein the circuit includes separation points that facilitate the creation of independent circuits from the single stamping.

10. The backplate assembly of claim 1, wherein the circuit includes a circuit body, terminal pins, and bulb contacts.

11. The backplate assembly of claim 10, wherein the bulb clips functionally engage the bulb contacts.

12. The backplate assembly of claim 1, wherein the bulb clips include a bulb receptacle and a mounting rod.

13. The backplate assembly of claim 3, wherein the longitudinal axis of the fastening screw passes through the front housing and the back housing in an orientation parallel to the longitudinal plane of the bulb clips.

14. A backplate assembly for a tail lamp comprising:
a front housing;
a back housing secured to the front housing;
a circuit disposed between the front housing and the back housing, wherein the circuit is a one-piece circuit formed from a single stamping process;
a plurality of bulb clips disposed partially between the front housing and the back housing and functionally engaging the circuit; and
at least one fastening screw, wherein the at least one fastening screw passes through the front housing and back housing to engage the tail lamp.

15. The backplate assembly of claim 1, wherein the longitudinal axis of the fastening screw passes through the front housing and the back housing in an orientation parallel to the longitudinal plane of the bulb clips.

16. The backplate assembly of claim 1, wherein the perimeter of the back housing and the perimeter of the front housing are ultrasonic welded together.

17. The backplate assembly of claim 1, further comprising at least one gasket mounted on the exterior of the back housing.

18. The backplate assembly of claim 1, wherein the bulb clips facilitate contact between the circuit of the backplate assembly and bulbs of the tail lamp assembly.

19. The backplate assembly of claim 1, wherein the circuit is stamped as a flat sheet and bent into shape for final assembly.

20. A tail lamp assembly for a vehicle, the tail lamp assembly comprising:
a tail lamp housing;
a plurality of reflectors disposed at least partially within the housing;
a backplate assembly including a front housing, a back housing secured to the front housing, a one-piece circuit disposed between the front housing and the back housing, a plurality of bulb clips disposed partially between the front housing and the back housing and functionally engaging the circuit, and at least one fastening screw;
at least one screw boss to receive the at least one fastening screw;
a plurality of bulbs mounted in the bulb clips to engage the circuit, the bulbs disposed between the reflectors and the tail lamp housing;
at least one gasket mounted on the exterior of the back housing of the backplate assembly; and
wherein the at least one fastening screw passes through the front housing and the back housing of the backplate assembly to engage the at least one screw boss.
